(19) United States
(12) Patent Application Publication
(10) Pub. No.: US 2026/0310542 A1
(43) Pub. Date: Oct. 8, 2026

(54) EVENT REMEDIATION BASED ON VISUAL DATA OBTAINED BY A MANAGEMENT CONTROLLER

(71) Applicant: Dell Products L.P., Round Rock, TX (US)

(72) Inventors: BRADLEY K. GOODMAN, Nashua, NH (US); CHRISTOPHER RONALD DION, Marlborough, MA (US); CURTIS J. SCHWEBKE, Round Rock, TX (US)

(21) Appl. No.: 19/169,694

(22) Filed: Apr. 3, 2025

(51) Int. Cl. G06F 11/07; G06F 11/30

(52) U.S. Cl. CPC G06F 11/0793; G06F 11/3072

(57) ABSTRACT

Methods and systems for managing operation of a data processing system are provided. To manage the data processing system, a management controller of the data processing system may obtain visual data generated by in-band components of the data processing system. The visual data may include textual and/or graphical information that may indicate an operating state of the data processing system. Based on the visual data, the management controller may infer an occurrence of an event impacting operation of the in-band components. The occurrence may be inferred using a set of rules and/or an inference model. The occurrence may also be verified to be valid using telemetry data obtained during the occurrence of the event. If determined to be valid, a remediation process may be performed to manage an impact of the occurrence of the event.

### FIELD

Embodiments disclosed herein relate generally to managing operation of a data processing system. More particularly, embodiments disclosed herein relate to by managing an occurrence of an event impacting the data processing system based on visual data obtained by a management controller.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show diagrams illustrating a system in accordance with an embodiment.

FIGS. 2A-2C show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may host in-band components (e.g., hardware resources) that may perform various processes such as startup processes, software installation processes, and/or any other types of processes. While performing a process, an event may occur that may impact operation of at least a portion of the in-band components and/or an ability of the portion of in-band components to complete performance of the process. The event may include, for example, a system crash, a startup failure, a process hang, and/or any other undesired behavior that may impair operation of the data processing system.

The occurrence of the event may be indicated by information (e.g., visual data) provided via an interface (e.g., a graphical user interface, a command line interface, etc.) of the data processing system. For example, a screen may be displayed (e.g., via a visual display system) that may be viewed by a user of the data processing system. Thus, an entity may be required to be local to the data processing system to identify and/or address the occurrence of the event. Furthermore, the visual data may not be natively interpretable by an executing entity (e.g., a processor of the hardware resources) of the data processing system while the hardware resources may be at least partially impaired due to the occurrence of the event.

To manage operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during a startup process and/or regardless of an outcome of the startup process performed by the hardware resources.

Thus, to reduce an impact of the occurrence of the event, the management controller may obtain the visual data generated by the hardware resources. For example, the management controller may continuously monitor video and/or capture a screenshot of the interface of the data processing system via a side band channel. The management controller may analyze the visual data to infer the occurrence of the event.

To infer the occurrence of the event, the management controller may process the visual data (e.g., the screenshot) to identify enhanced information (e.g., textual and/or graphical information present in the screenshot of the interface). To do so, the management controller may perform an image recognition process, optical character recognition process, and/or any other process to derive the enhanced information (e.g., strings of text, glyphs, screen color, layout, etc.) from the visual data. The enhanced information may be used as input to a detection system to infer the occurrence of the event.

The detection system may include, for example, a set of rules (e.g., defined by a subject matter expert) that may map and/or filter events based on corresponding portions of the enhanced information, an inference model (e.g., a machine learning model) trained to generate an inference regarding the occurrence of the event, and/or any other detection mechanism. The inference may be made, at least indirectly, based on an inferred operating state of the hardware resources and/or a status of a process performed by the hardware resources indicated by the visual data.

After inferring the occurrence of the event, an event verification process may be performed to verify the occurrence of the event. To do so, the management controller may obtain telemetry data for at least a portion of the hardware resources via a second side band channel. The telemetry data may include, for example, performance metrics for hardware components, activity of the hardware components, user interaction data, network data, and/or any other type of data regarding operation of the data processing system during the occurrence of the event. Thus, to verify the occurrence of the event, the telemetry data may be compared to the visual data to determine whether the telemetry data and the visual data are consistent with respect to the occurrence of the event. By doing so, a likelihood that an invalid occurrence of an event (e.g., an attempt to spoof the event, a false positive for the occurrence, etc.) is identified may be reduced.

The management controller may subsequently identify a remediation process in response to concluding that the data processing system is at least partially impaired due to the occurrence of the event. To do so, the management controller may identify an undesired behavior of the data processing system based at least on the occurrence of the event and search a remediation process repository using the undesired behavior as a key to identify the remediation process. For example, the data processing system may be identified to be suspended on a startup screen for a period of time that exceeds a threshold period of time, a remediation process may be identified that may include an action to reset the data processing system. Once identified, the management controller may initiate performance of the remediation action to facilitate continued provisioning of desired computer-implemented services by the data processing system.

In an embodiment, a method for managing operation of a data processing system is provided. The method may include: (i) obtaining, by a management controller, visual data generated by in-band components of the data processing system, the visual data being adapted for consumption by a user of the data processing system and not being natively interpretable by an executing entity of the data processing system; (ii) inferring, by the management controller and using the visual data, an occurrence of an event impacting operation of the in-band components of the data processing system; (iii) identifying, by the management controller, a remediation process to manage an impact of the occurrence; and (iv) initiating, by the management controller, performance of the remediation process by the data processing system to place the data processing system in a desired operating state to facilitate continued provisioning of desired computer implemented services.

The method may also include: (i) after inferring the occurrence of the event: (a) performing, by the management controller and using a side band channel between the management controller and at least one of the in-band components, an event verification process for the occurrence; and (b) in a first instance of the performing where the event verification process for the occurrence indicates that the occurrence is valid: (i) concluding that the data processing system is at least partially impaired, wherein the remediation process is identified in response to concluding that the data processing system is at least partially impaired.

Performing the event verification process may include: (i) obtaining, using the side band channel, telemetry data for the at least one of the in-band components, the telemetry data indicating characteristics of the at least one of the in-band components during the occurrence of the event; (ii) making a determination regarding whether the telemetry data is consistent with the visual data with respect to the occurrence of the event; and (iii) in a first instance of the determination where the telemetry data is consistent with the visual data: (a) concluding that the occurrence is valid.

The visual data may include a screenshot of an interface of the data processing system while the in-band components are performing a process, the interface indicating a status of the process and/or an operating state of the in-band components.

Inferring the occurrence of the event may include: (i) obtaining enhanced information based on the visual data; and (ii) inferring, using a detection system, that the event has occurred based on the enhanced information.

The enhanced information may include at least one type of information from a list consisting of: (i) textual information present in the visual data; and (ii) graphical information present in the visual data.

The graphical information may include at least one attribute from a list of attributes consisting of: (i) an image; (ii) typography; (iii) color; and (iv) layout.

The detection system may include a set of rules used to infer the occurrence of the event based on the visual data, the set of rules being defined by a subject matter expert.

The detection system may include an inference model trained to generate an inference regarding the occurrence of the event based on the visual data, the inference model being trained using second visual data.

Identifying the remediation process may include: (i) identifying an undesired behavior of the data processing system based at least on the occurrence of the event; and (ii) searching a remediation process repository using the undesired behavior as a key to identify the remediation process.

The remediation process repository may be managed by a remote management system tasked with managing operation of the data processing system.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

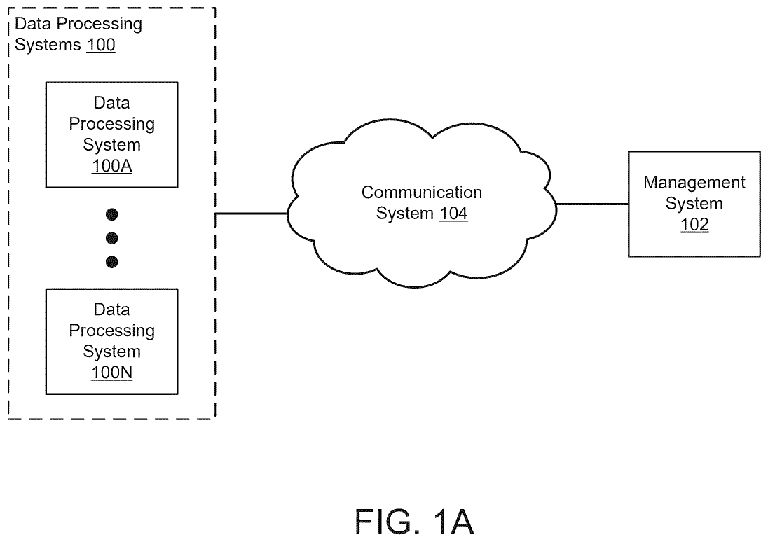

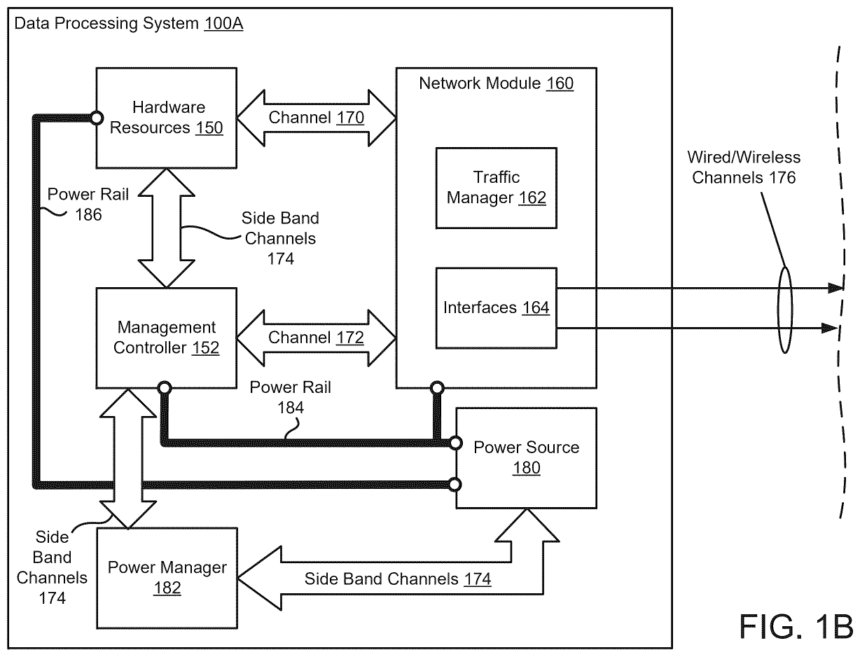

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding a data processing system of data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by in-band components (e.g., hardware resources) of data processing systems 100. While providing the computer-implemented services, an event may occur that may impact operation of at least a portion of the in-band components and/or an ability of the portion of in-band components to complete performance of the process. The event may include, for example, a system crash, a startup failure, a process hang, and/or any other undesired behavior that may at least partially impair operation of the data processing system.

The occurrence of the event may be indicated by information (e.g., visual data) provided via an interface (e.g., a graphical user interface, a command line interface, etc.) of the data processing system. For example, consider a scenario in which an operating system of the data processing system encounters a critical error while performing a process. The data processing system may display a critical error screen (e.g., a blue screen of death) that may include any number and/or type of information adapted to be viewed by a user of the data processing system. Accordingly, an entity may be required to be local to the data processing system to identify and/or address the occurrence of the event.

Furthermore, the visual data may not be natively interpretable by an executing entity (e.g., a processor of the hardware resources) of the data processing system while the hardware resources may be at least partially impaired due to the occurrence of the event.

To manage operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during a startup process and/or regardless of an outcome of the startup process performed by the hardware resources. To provide its functionality, the management controller may collect information regarding operation of the in-band components, provide the information to an entity tasked with managing operation of the data processing system (e.g., via logging, reporting, etc.), modify operation of the data processing system based on the information, and/or perform any other actions.

However, an availability and/or quality of the information may be insufficient for addressing the occurrence of the event impacting operation of the in-band components of the data processing system. For example, the management controller may obtain a predetermined set of information regarding the operation of the in-band components. An event may occur that may not be identifiable (e.g., at least directly) based on the predetermined set of information. Furthermore, as previously discussed, the information may not be usable by an entity capable of addressing the occurrence of the event. For example, a user local to the data processing system may not have the ability to remediate the event (e.g., due to a limited knowledge base), a remote management entity may not have access to the information, and/or any other limitations may prevent the occurrence of the event from being addressed.

In general, embodiments disclosed herein relate to systems, devices, and methods for managing operation of a data processing system. To manage the operation of a data processing system, the management controller may initiate performance of a remediation process based on an inference that an event has occurred that may impact operation of the in-band components. The inference may be made by the management controller based on visual data generated by the in-band components of the data processing system and obtained by the management controller via a side band channel. The visual data may include, for example, a screenshot of an interface of the data processing system that may indicate an operation state of the in-band components and/or a status of a process performed by the in-band components.

To obtain the visual data, the management controller may, for example, continuously monitor video, capture a screenshot of the interface of the data processing system based on a schedule, and/or perform any other actions. The management controller may analyze the visual data to infer the occurrence of the event. To infer the occurrence of the event, the management controller may process the visual data (e.g., the screenshot) to identify enhanced information (e.g., textual and/or graphical information present in the screenshot of the interface). To do so, the management controller may perform an image recognition process, optical character recognition process, and/or any other process to derive the enhanced information (e.g., strings of text, glyphs, screen color, layout, etc.) from the visual data. The enhanced information may be used as input to a detection system to infer the occurrence of the event.

The detection system may include, for example, a set of rules (e.g., defined by a subject matter expert) that may map and/or filter events based on corresponding portions of the enhanced information, an inference model (e.g., a machine learning model) trained to generate an inference regarding the occurrence of the event, and/or any other detection mechanism. The inference may be made, at least indirectly, based on an inferred operating state of the hardware resources and/or a status of a process performed by the hardware resources indicated by the visual data.

For example, consider a scenario in which an error screen is displayed on the data processing system. A screenshot of the error screen may be used by the management controller as input to be analyzed using a set of rules. The set of rules may include, for example, a determination regarding whether the color of a background of the screenshot is a certain color (e.g., blue, black, etc.), a certain image is present in a certain location (e.g., a frowny-face glyph being present at relative location on the screen), a barcode (e.g., a quick response code) is present, a predefined string of text is displayed, and/or any other indicators being identified using the visual data.

The detection system may also include, as previously discussed, an inference model. For example, the screenshot may be ingested to the inference model, processed to obtain information usable by the inference model (e.g., tokenized textual vectors, pixel vectors, etc.), and/or any other processes may be performed to obtain an output. The output may include, for example, an inference for the operating state of the data processing system (e.g., normal operation, system booting, system crashed, power cycling, etc.), a level of confidence for the inference, and/or any other information.

After inferring the occurrence of the event, an event verification process may be performed to verify the occurrence of the event. To do so, the management controller may obtain telemetry data for at least a portion of the hardware resources via a second side band channel. The telemetry data may include, for example, performance metrics for hardware components, activity of the hardware components, user interaction data, network data, and/or any other type of data regarding operation of the data processing system during the occurrence of the event. Thus, to verify the occurrence of the event, the telemetry data may be compared to the visual data to determine whether the telemetry data and the visual data are consistent with respect to the occurrence of the event. By doing so, a likelihood that an invalid occurrence of an event (e.g., an attempt to spoof the event, a false positive for the occurrence, etc.) is identified may be reduced.

The management controller may subsequently identify a remediation process in response to concluding that the data processing system is at least partially impaired due to the occurrence of the event. To do so, the management controller may identify an undesired behavior of the data processing system based at least on the occurrence of the event and search a remediation process repository using the undesired behavior as a key to identify the remediation process. For example, the data processing system may be identified to be suspended on a startup screen for a period of time that exceeds a threshold period of time, a remediation process may be identified that may include an action to reset the data processing system. Once identified, the management controller may initiate performance of the remediation action to facilitate continued provisioning of desired computer-implemented services by the data processing system.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, each data processing system (e.g., 100A, 100B, etc.) of data processing systems 100 may communicate with and/or obtain information from management system 102. For example, data processing system 100A may obtain an event policy relevant to a detection system for inferring occurrences of events, obtain instructions relevant to use of the detection system, obtain updated information regarding remediation processes, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may generate and provide the event policy to at least a portion of data processing systems of data processing systems 100, obtain data (e.g., visual data, responses, outcomes of remediation processes, etc.) from the portion of data processing systems, evaluate the data regarding operation of the data processing systems, update the event policy (e.g., use of a detection system, remediation processes, etc.) and/or provide any other services to manage operation of data processing systems 100.

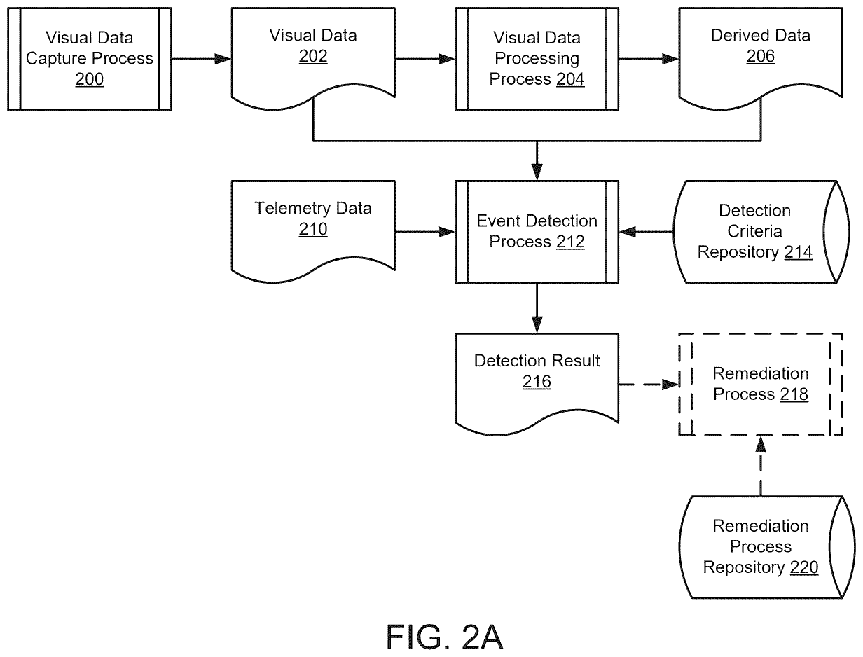

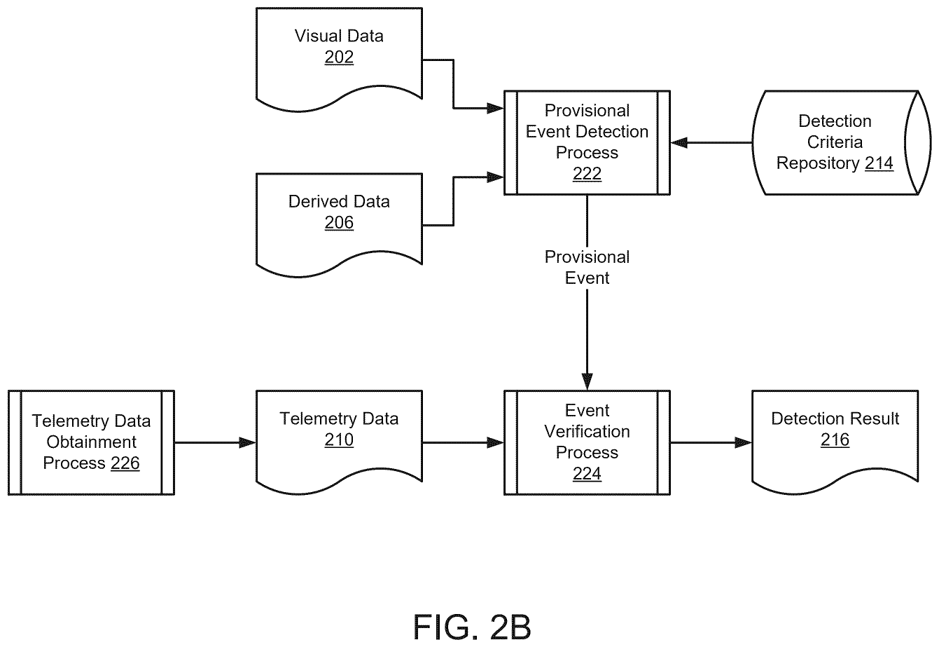

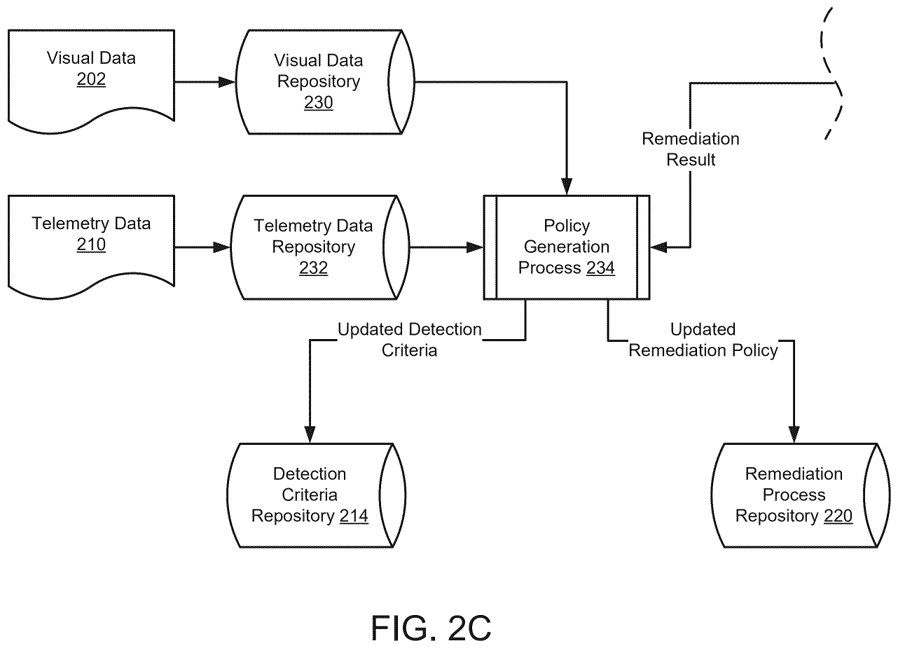

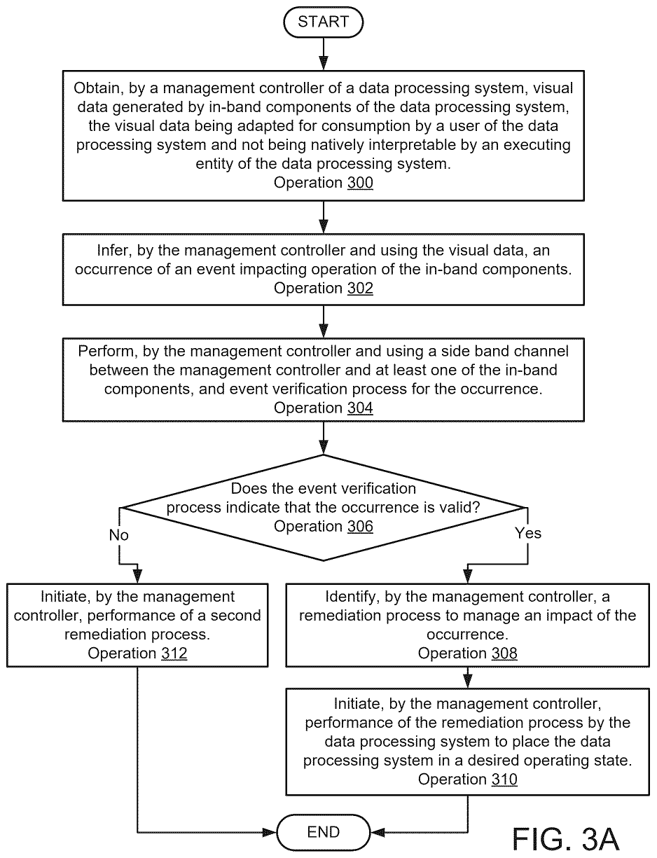

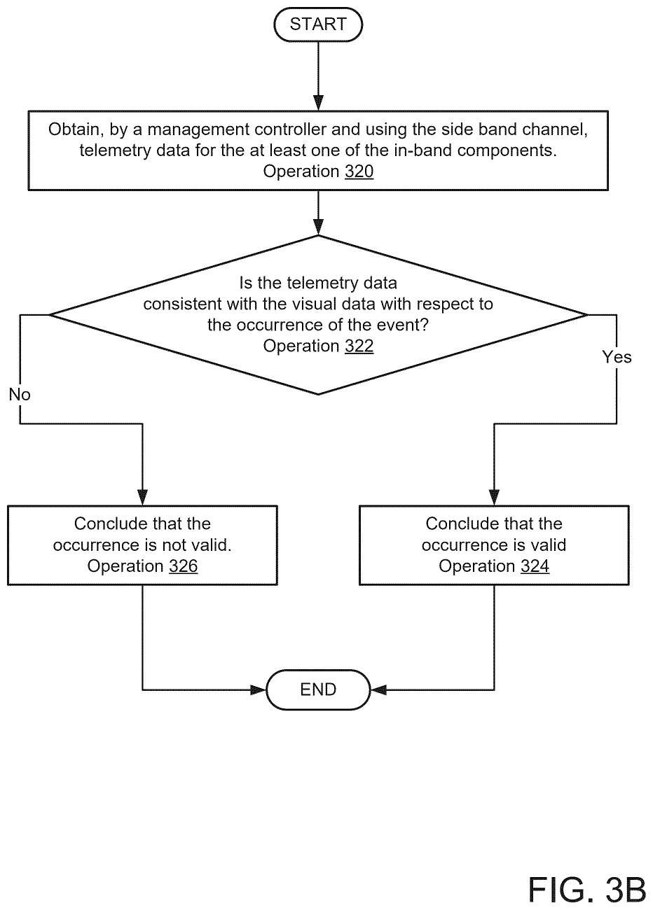

While providing their functionality, any of data processing systems 100, and management system 102 may provide all or a portion of the methods shown in FIGS. 2A-3B.

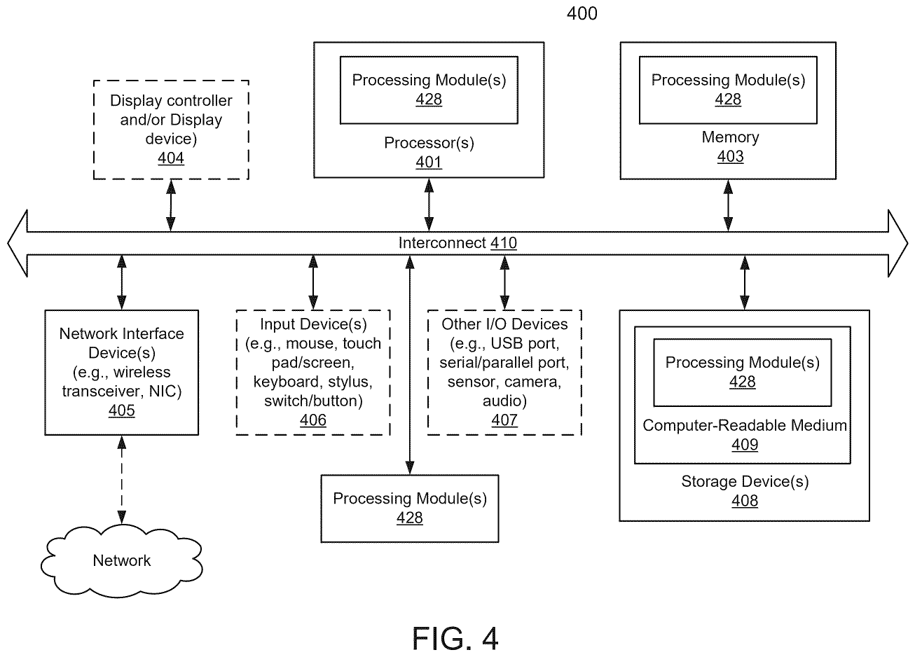

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by using a management controller to infer an occurrence of an event impacting operation of the data processing system based on visual data obtained via a side band channel. By doing so, the management controller may perform a remediation process to reduce an impact of the occurrence of the event to facilitate continued provisioning of desired computer-implemented services by the data processing system.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system). Management controller 152 may provide various management functionalities for data processing system 100A. For example, management controller 152 may monitor various ongoing processes performed by the in-band components, may manage power distribution, thermal management, and/or other functions of data processing system 100A.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may obtain visual data (e.g., a screenshot, video, etc.) from a visual display system of data processing system 100A via a side band channel, infer an occurrence of an event impacting operation of at least a portion of hardware resources 150 based on the visual data, perform an event verification process to conclude that the data processing system is at least partially impaired, initiate performance of a remediation process (e.g., power cycling, transmitting an alert, modifying configurations, etc.) to place the data processing system in a desired operating state, and/or perform any other actions.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

For example, management controller 152 may provide information (e.g., the visual data, telemetry data, outcomes of a remediation process, etc.) regarding the operation of data processing system 100A to a remote management entity (e.g., management system 102) using channel 172, obtain updated information usable to manage data processing system 100A from the remote management entity, and/or perform any other actions via communication with other devices.

To facilitate communication with the other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

Therefore, management controller 152 may communicate the telemetry data regarding operation of the storage device to management system 102, obtain a remediation package from management system 102, and/or cooperatively perform any other management functionalities via communication of information using an out-of-band communication channel (e.g., channel 172).

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3B.

While illustrated in FIG. 1B with a limited number of specific components, a system may include additional, fewer, and/or different components without departing from embodiments disclosed herein.

To further clarify embodiments disclosed herein, data flow diagrams in accordance with an embodiment are shown in FIGS. 2A-2B. The data flow diagrams may illustrate how data is obtained and used within the system of FIGS. 1A-1B. In these diagrams, flows of data and processing of data are illustrated using different sets of shapes. A first set of shapes (e.g., 202, 210, etc.) is used to represent data structures, a second set of shapes (e.g., 200, 204, etc.) is used to represent processes performed using and/or that generate data, and a third set of shapes (e.g., 214, 220, etc.) is used to represent large scale data structures such as databases.

Turning to FIG. 2A, a first data flow diagram in accordance with an embodiment is shown. The first data flow diagram may illustrate data used in and data processing performed in managing an impact of an occurrence of an event impacting operation of the data processing system.

To manage the impact of the occurrence, visual data capture process 200 may be performed to obtain visual data 202 that may be relevant to operation of in-band components (e.g., hardware resources 150) of data processing system 100A. During visual data capture process 200, the management controller may obtain visual data 202 from the hardware components. For example, to obtain visual data 202, the management controller may communicate with the hardware resources using a side band channel to obtain a screenshot indicating a status of a process being performed by the hardware resources. To do so, the management controller may read information from a graphics adapter or other type of hardware device that manages display of information on a display panel. The information may be kept, for example, in a frame buffer or other data storage structure that defines information for pixels in the display. Reading the frame buffer may allow the management controller to construct a screenshot of the information displayed on a display. The management controller may continuously monitor the data processing system to obtain video, capture screenshots based on a schedule and/or trigger condition, and/or via any other processes.

Visual data 202 may include any number and/or type of information regarding an operating state of the data processing system. For example, visual data 202 may include a video recording, one or more screenshots of an interface (e.g., a graphical user interface, a command line interface, etc.) of the data processing system, and/or any other information.

To obtain enhanced information (e.g., meaningful information) from the visual data, visual data processing process 204 may be performed. During visual data processing process 204, visual data 202 may be ingested by the management controller and analyzed to obtain derived data. For example, visual data 202 may be used in various image processing processes to enhance the quality of the image, derive information from visual data 202, and/or otherwise obtain information from visual data 202. Visual data processing process 204 may include utilizing techniques (e.g., optical character recognition, textual information preprocessing, textual analysis using natural language processing, etc.) to extract visual features and detect objects or regions of interest (e.g., within visual data 202).

For example, visual data processing process 204 may include (i) identifying areas of interest in the screenshot (e.g., areas where graphical information is shown, areas where characters corresponding to words describing events/activities/etc. that occur during a process, etc.), (ii) segmenting the screenshot into segments to obtain screenshot segments, and/or (iii) identifying strings of text present in the screenshot, (iv) identifying graphical attributes (e.g., images, typography, color, layout, etc.) of the screenshot, and/or performing any other processes to obtain derived data 206.

Derived data 206 may, as previously discussed, include any number and/or type of enhanced information derived using visual data 202. Derived data may include, for example, a graphical information (e.g., logos, spinners, graphics, icons, codes, etc.), positioning and color information (e.g., foreground, background, empty areas), textual information (e.g., strings of text, characters, etc.), and/or any other information usable to identify an operating state of the data processing system.

To identify that an event has occurred that may impact operation of the data processing system, event detection process 212 may be performed. During event detection process 212, an occurrence of an event may be inferred based on the visual data and an event verification process may be performed to verify a validity of the occurrence. For example, the occurrence of the event may be inferred by ingesting visual data 202 and/or derived data 206 as input to a detection system to obtain a provisional inference regarding the occurrence of the event. The detection system may be obtained from detection criteria repository 214 and may include, for example, a set of rules used to infer the occurrence of the event, an inference model (e.g., a machine learning model) trained to generate an inference, and/or any other method to infer the occurrence of the event based on visual data. Detection criteria repository 214 may be obtained and/or updated based at least in part, on historic visual data. Refer to FIG. 2C for additional details regarding managing detection criteria repository 214.

After inferring the occurrence of the event, the management controller may perform an event verification process for the occurrence to determine whether the occurrence was valid. To perform the event verification process, the management controller may obtain telemetry data 210 for at least one in-band component during the occurrence of the event using a side band channel. By doing so, detection result 216 may be obtained and used to identify a remediation process to be performed. Refer to FIG. 2B for additional details regarding performing the event detection process (e.g., 212) to obtain detection result 216.

Detection result 216 may indicate, for example, that the event has occurred that may at least partially impair operation of the data processing system. It may also indicate an operating state of the data processing system (e.g., system booting, system crashed, abnormal operation, etc.) based on the occurrence of the event.

To address the occurrence of the event, remediation process 218 may be performed based on detection result 216. The data flow to remediation process 218 is shown in long-dashed lines to indicate that remediation process 218 may not be performed in an instance where detection result 216 indicates that the occurrence of the event is not valid (e.g., the data processing system is already in a desired operating state). During remediation process 218, an undesired behavior of the data processing system may be identified, a remediation process may be identified based on the undesired behavior, and the remediation process may be performed to place the data processing system in a desired operating state. For example, to identify the undesired behavior, the management controller may identify additional information regarding the occurrence of the event (e.g., a duration of the event, a frequency of the event, previous attempts to address the event, etc.).

The management controller may use the information and/or detection result 216 to identify a remediation process to address the event. For example, the management controller may search remediation process repository 220 using the identified undesired behavior as key, implement a set of rules (e.g., an event handler) to identify a set of actions, and/or perform any other actions. Remediation process repository 220 may include any number and/or type of information regarding remediation processes to perform in response to an occurrence of an event. Remediation process repository 220 may be defined by a remediation policy managed by management system 102 and may include, for example, a list of actions mapped to corresponding undesired behaviors and/or events. Remediation process repository 220 may be obtained and/or updated based on a policy that may be managed management system 102. Refer to FIG. 2C for additional details regarding managing remediation process repository 220.

Once identified, the management controller may initiate performance of the remediation process to update operation of the data processing system. For example, the management controller may provide instructions to a processor of the hardware resources to perform at least one action via a side band channel, transmit information (e.g., logs, visual data, telemetry data, etc.) to a remote management entity via an out-of-band communication channel, install updated software, send a signal to a power supply unit of the data processing system (e.g., to depower, power cycle, etc.) via a second side band channel, and/or perform any other actions.

Thus, using the data flow shown in FIG. 2A, a management controller of a data processing system may perform a remediation process based on visual data obtained from in-band components of the data processing system. By doing so, an impact of an occurrence of an event impacting operation of the in-band components may be reduced so that continued provisioning of desired computer-implemented services may be provided by the data processing system.

Turning to FIG. 2B, a second data flow diagram in accordance with an embodiment is shown. The second data flow diagram may illustrate data used in and data processing performed in identifying that the data processing system is at least partially impaired based on an inference that an event has occurred impacting in-band components of the data processing system.

To infer that the event has occurred, provisional event detection process 222 may be performed. During provisional event detection process 222, visual data 202 and/or derived data 206 may be evaluated based on detection criteria to provisionally infer the occurrence of the event. For example, as previously discussed in FIG. 2A, the management controller may use visual data 202 and/or derived data 206 as input to a detection system that may be defined the remote management system. The detection system may include, for example, a set of rules that may be implemented to filter and/or map portions of derived data 206 to a likelihood of an event based on corresponding rules of the set of rules. The set of rules may be implemented, for example, in a predetermined order to improve a computational efficiency of the detection process.

The detection system may also include, as previously discussed, an inference model. For example, a screenshot of visual data 202 and/or derived data 206 (e.g., tokenized textual vectors, pixel vectors, etc.) may be ingested by the inference model to obtain an output. The output may include, for example, an inference for the operating state of the data processing system (e.g., normal operation, system booting, system crashed, power cycling, etc.), a level of confidence for the inference, and/or any other information regarding the provisionally inferred occurrence of the event.

However, an invalid occurrence of an event may occur based on the provisional inference based on the visual data. For example, the event may be identified in an instance where the user intentionally displays a critical error screen (e.g., by loading a static image of the critical error screen for research purposes). Furthermore, a malicious entity may intentionally display the critical error screen to attempt to trigger an action (e.g., restart) that may place the data processing system in a potentially compromised state (e.g., reduced security measures, limited operating state, etc.).

To reduce a likelihood that an invalid occurrence of the event is identified, event verification process 224 may be performed. During event verification process 224, the provisional event may be compared to telemetry data 210 to determine whether the provisionally inferred event is consistent with telemetry data 210. For example, consider the previous scenario in which a malicious entity attempts to spoof the display of the critical error screenshot. Telemetry data 210 may indicate activity that may contradict the visual data (e.g., the critical error screenshot. For example, telemetry data 210 may indicate that processes are being performed that may not otherwise be performed if the event (e.g., the certain critical error) has occurred, user interactions (e.g., keyboard inputs, mouse clicks, etc.) may be registered that may not otherwise be available, and/or any other indicators that the provisional event may not be valid based on the visual data and/or the derived data. By doing so, detection result 216 may, as previously discussed in FIG. 2A, be obtained that may have a higher level of quality for remediating the occurrence of the event.

Telemetry data 210 may be obtained by performing telemetry data obtainment process 226. During telemetry data obtainment process 226, the management controller may obtain any number and/or type of data from the in-band components regarding the operation of the in-band components. For example, information regarding operation of a processor (e.g., temperature data, processing speed, etc.) while a process is being performed, information relating to the hardware resources that are contributing to performance of the process, and/or any other type of information may be collected and transmitted to the management controller.

Thus, using the data flow shown in FIG. 2B, an occurrence of an event may be inferred based on visual data and a validity of the occurrence may be verified using telemetry data. By doing so, a quality of a remediation process performed based on the occurrence may be improved.

Turning to FIG. 2C, a third data flow diagram in accordance with an embodiment is shown. The third data flow diagram may illustrate data used in and data processing performed in managing a detection criteria repository and/or a remediation process repository.

To manage the detection criteria repository (e.g., 214) and/or the remediation process repository (e.g., 220), policy generation process 234 may be performed. During policy generation process 234, a policy may be obtained that may be used to define and/or update use of a detection system and/or remediation processes using by data processing systems 100. To do so, a remote management entity (e.g., management system 102) may obtain a plurality of historic information (e.g., visual data, telemetry data, remediation results, etc.) that may be stored in one or more repositories (e.g., visual data repository 230, telemetry data repository 232, etc.). The remediation result may be obtained from a data processing system based on an outcome of performing a previous remediation process in response to an occurrence of an event.

Visual data repository 230 may include any number and/or type of information regarding visual data 202 and/or information derived from visual data 202. Visual data repository 230 may be hosted, for example, by each data processing system of data processing systems 100 and/or by the remote management entity. For example, the remote management entity may aggregate any number and/or type of visual data from a plurality of the data processing systems to be used in policy generation process 234 and/or any other processes.

Telemetry data repository 232 may similarly include any number and type of information regarding operation of at least a portion of data processing systems 100. For example, the remote management entity may aggregate any number and/or type of telemetry data from the portion of the data processing systems to be used in policy generation process 234 and/or any other processes.

To generate the updated detection criteria and/or the updated remediation policy, the remote management entity may analyze the plurality of information, train an inference model using the plurality of information (e.g., to obtain parameters for a new inference model), define/modify a set of rules (e.g., by a subject matter expert that manage the remote management entity) for inferring an occurrence of future events, and/or perform any other processes. By doing so, the updated detection criteria and/or the updated remediation policy may be provided to detection criteria repository 214 and remediation process repository 220 to be used subsequent management of data processing systems 100.

Thus, using the data flow shown in FIG. 2C, a policy may be obtained based on historic information and may improve an ability of data processing systems to infer an occurrence of an event and/or perform remediation processes to reduce an impact of the occurrence.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1B may perform various methods to manage a data processing system. FIGS. 3A-3B illustrate methods that may be performed by the components of the system of FIGS. 1A-1B. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing operation of a data processing system in accordance with an embodiment is shown. The method may be performed, for example, by any of the components of the system of FIGS. 1A-1B, and/or other components not shown therein.

At operation 300, visual data may be obtained by a management controller of the data processing system. The visual data may be obtained by: (i) monitoring operations and/or processes performed by the data processing system via a side band channel, (ii) reading video output being generated by a visual display system of the data processing system, (iii) capturing screenshots of the video output based on a schedule and/or predefined conditions, and/or performing any other actions.

At operation 302, an occurrence of an event impacting operation of the in-band components may be inferred using the visual data. The occurrence of the event may be inferred by: (i) processing the visual data (e.g., using optical character recognition, image recognition, textual information preprocessing, natural language processing, etc.) to derive meaningful information from the visual data, (ii) implementing a set of rules (e.g., detection criteria) to the derived information, (iii) generating an inference regarding an operating state of the in-band components using the visual data and/or the derived information as inputs to a trained inference model, and/or via any other processes.

At operation 304, an event verification process may be performed by the management controller and using a side band channel between the management controller and at least one of the in-band components. The event verification process may be performed by obtaining telemetry data from the at least one of the in-band components, and comparing the telemetry data to the visual data. Refer to FIG. 3B for additional details regarding performing the event verification process.

At operation 306, a determination may be made regarding whether the performing of the event verification process indicates that the occurrence is valid. The determination may be made by: (i) comparing the telemetry data to the visual data and/or the derived information to identify a level of consistency, (ii) identifying activity of the data processing system during the occurrence of the event and based on the telemetry data, and/or performing any other processes. If the occurrence is determined to be valid (e.g., the determination is “Yes” at operation 306), the method may proceed to operation 308. If the occurrence is determined to be not valid (e.g., the determination is “No” at operation 306), the method may proceed to operation 312 following operation 306.

At operation 308, a remediation process may be identified by the management controller to manage an impact of the occurrence of the event. The remediation process may be identified by: (i) identifying additional information regarding the occurrence of the event (e.g., a duration of the event, a frequency of the event, previous attempts to address the event, etc.), (ii) identifying an undesired behavior of the data processing system based on the additional information and/or the event, (iii) searching a remediation policy repository using the undesired behavior, and/or performing any other actions.

At operation 310, performance of the remediation process by the data processing system may be initiated by the management controller to place the data processing system in a desired operating state. The performance of the remediation process may be initiated by: (i) providing instructions to a processor of the in-band components to place the data processing system in a pre-boot execution environment, (ii) transmitting information (e.g., logs, visual data, telemetry data, alerts, etc.) to a remote management entity via an out-of-band communication channel, (iii) installing updated software (e.g., based on a system data recovery policy), (iv) sending a signal to a power supply unit of the data processing system (e.g., to depower, power cycle, etc.), and/or performing any other actions.

The method may end following operation 310.

Returning to operation 306, the method may proceed to operation 312 following operation 306 when the event verification process indicates that the occurrence of the event is not valid.

At operation 312, performance of a second remediation process may be initiated by the management controller based on indication that the occurrence of the event is not valid based on the visual data. The performance of the second remediation process may include, for example: (i) sending an alert to the remote management entity (e.g., that may be of a lower priority than an alert sent based on the determination that the occurrence of the event is valid), (ii) logging the occurrence and/or a result of the event verification process, (iii) ignoring the inferred occurrence, and/or performing any other actions.

The method may end following operation 312.

Using the method shown in FIG. 3A, operation of a data processing system may be managed using a management controller to infer an occurrence of an event impacting operation of the data processing system based on visual data obtained via a side band channel. Furthermore, the occurrence may be validated by performing an event verification process. By doing so, the management controller may perform a remediation process to reduce an impact of the occurrence of the event to facilitate continued provisioning of desired computer-implemented services by the data processing system.

Turning to FIG. 3B, a second flow diagram illustrating a method of managing operation of a management controller of a data processing system in accordance with an embodiment is shown. The method may be performed, for example, by any of the components of the system of FIGS. 1A-1B, and/or other components not shown therein.

At operation 320, telemetry data may be obtained for at least one of the in-band components by the management controller and using the side band channel. The telemetry data may be obtained by: (i) reading a process queue used by a processor to obtain information regarding operation of a processor (e.g., temperature data, processing speed, etc.), (ii) monitoring a statue of a startup process being performed (e.g., while the processor is managed by a basic input/output system), (iii) querying in-band components (e.g., memory, storage, etc.) for information regarding each in-band components contribution to a process, and/or performing any other actions.

At operation 322, a determination may be made regarding whether the telemetry data is consistent with the visual data with respect to the occurrence of the event. The determination may be made by: (i) comparing a timing of the occurrence of the event relative to activity indicated by the telemetry data, (ii) identifying whether user interaction (e.g., keyboard input, mouse clicks, etc.) may have deliberately contributed to the event, (iii) identifying whether at least a portion of the in-band components may be in a reduced operating state during and/or due to the occurrence of the event, and/or via any other processes. If the telemetry data is determined to be consistent with the visual data (e.g., the determination is “Yes” at operation 322), the method may proceed to operation 324. If the telemetry data is determined to not be consistent with the visual data (e.g., the determination is “No” at operation 322), the method may proceed to operation 326 following operation 322.

At operation 324, the occurrence may be concluded to be valid by the management controller. The occurrence may be concluded by: (i) assigning a level of confidence to the determination that the telemetry data is consistent with the visual data; (ii) initiating identification of a remediation process for the occurrence, and/or performing any other actions.

The method may end following operation 324.

Returning to operation 322, the method may proceed to operation 326 following operation 322 when telemetry data is determined to not be consistent with the visual data with respect to the occurrence of the event.

At operation 326, the occurrence may be concluded to not be valid by the management controller. The occurrence may be concluded to be not valid by: (i) disregarding the inference and/or visual data; (ii) initiating performance of the second remediation process for the occurrence, and/or performing any other actions.

The method may end following operation 326.

Using the method shown in FIG. 3B, an inference that an event has occurred based on visual data may be verified using telemetry data obtained from the in-band components of the data processing system to determine with the telemetry data is consistent with the visual data with respect to the occurrence of the event. By doing so, a likelihood that an invalid occurrence of an event (e.g., spoofing by a malicious entity, false positives during a detection of the event, etc.) is addressed (e.g., that may place the data processing system in an undesired and/or potentially compromised operating state) may be reduced.

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO (Input/Output) devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen. IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random-access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system, the method comprising:
obtaining, by a management controller, visual data generated by in-band components of the data processing system, the visual data being adapted for consumption by a user of the data processing system and not being natively interpretable by an executing entity of the data processing system;
inferring, by the management controller and using the visual data, an occurrence of an event impacting operation of the in-band components of the data processing system;
identifying, by the management controller, a remediation process to manage an impact of the occurrence; and
initiating, by the management controller, performance of the remediation process by the data processing system to place the data processing system in a desired operating state to facilitate continued provisioning of desired computer implemented services.

2. The method of claim 1, further comprising:
after inferring the occurrence of the event:
performing, by the management controller and using a side band channel between the management controller and at least one of the in-band components, an event verification process for the occurrence; and
in a first instance of the performing where the event verification process for the occurrence indicates that the occurrence is valid:
concluding that the data processing system is at least partially impaired,
wherein the remediation process is identified in response to the concluding that the data processing system is at least partially impaired.

3. The method of claim 2, wherein performing the event verification process comprises:
obtaining, using the side band channel, telemetry data for the at least one of the in-band components, the telemetry data indicating characteristics of the at least one of the in-band components during the occurrence of the event;
making a determination regarding whether the telemetry data is consistent with the visual data with respect to the occurrence of the event; and
in a first instance of the determination where the telemetry data is consistent with the visual data:
concluding that the occurrence is valid.

4. The method of claim 1, wherein the visual data comprises a screenshot of an interface of the data processing system while the in-band components are performing a process, the interface indicating a status of the process and/or an operating state of the in-band components.

5. The method of claim 1, wherein inferring the occurrence of the event comprises:
obtaining enhanced information based on the visual data; and
inferring, using a detection system, that the event has occurred based on the enhanced information.

6. The method of claim 5, wherein the enhanced information comprises at least one type of information from a list consisting of:
textual information present in the visual data; and
graphical information present in the visual data.

7. The method of claim 6, wherein the graphical information comprises at least one attribute from a list of attributes consisting of:
an image;
typography;
color; and
layout.

8. The method of claim 5, wherein the detection system comprises a set of rules used to infer the occurrence of the event based on the visual data, the set of rules being defined by a subject matter expert.

9. The method of claim 5, wherein the detection system comprises an inference model trained to generate an inference regarding the occurrence of the event based on the visual data, the inference model being trained using second visual data.

10. The method of claim 1, wherein identifying the remediation process comprises:
identifying an undesired behavior of the data processing system based at least on the occurrence of the event; and
searching a remediation process repository using the undesired behavior as a key to identify the remediation process.

11. The method of claim 10, wherein the remediation process repository is managed by a remote management system tasked with managing operation of the data processing system.

12. A non-transitory machine-readable medium having instructions stored therein, which when executed by a processor, cause operations for managing operation of a data processing system to be performed, the operations comprising:
obtaining, by a management controller, visual data generated by in-band components of the data processing system, the visual data being adapted for consumption by a user of the data processing system and not being natively interpretable by an executing entity of the data processing system;
inferring, by the management controller and using the visual data, an occurrence of an event impacting operation of the in-band components of the data processing system;
identifying, by the management controller, a remediation process to manage an impact of the occurrence; and
initiating, by the management controller, performance of the remediation process by the data processing system to place the data processing system in a desired operating state to facilitate continued provisioning of desired computer implemented services.

13. The non-transitory machine-readable medium of claim 12, wherein the operations further comprise:
after inferring the occurrence of the event:
performing, by the management controller and using a side band channel between the management controller and at least one of the in-band components, an event verification process for the occurrence; and
in a first instance of the performing where the event verification process for the occurrence indicates that the occurrence is valid:
concluding that the data processing system is at least partially impaired,
wherein the remediation process is identified in response to the concluding that the data processing system is at least partially impaired.

14. The non-transitory machine-readable medium of claim 13, wherein performing the event verification process comprises:
obtaining, using the side band channel, telemetry data for the at least one of the in-band components, the telemetry data indicating characteristics of the at least one of the in-band components during the occurrence of the event;
making a determination regarding whether the telemetry data is consistent with the visual data with respect to the occurrence of the event; and
in a first instance of the determination where the telemetry data is consistent with the visual data:
concluding that the occurrence is valid.

15. The non-transitory machine-readable medium of claim 12, wherein the visual data comprises a screenshot of an interface of the data processing system while the in-band components are performing a process, the interface indicating a status of the process and/or an operating state of the in-band components.

16. The non-transitory machine-readable medium of claim 12, wherein inferring the occurrence of the event comprises:
obtaining enhanced information based on the visual data; and
inferring, using a detection system, that the event has occurred based on the enhanced information.

17. A system, comprising:
a processor; and
a memory coupled to the processor to store instructions, which when executed by the processor, cause operations for managing operation of a data processing system to be performed, the operations comprising:
obtaining, by a management controller, visual data generated by in-band components of the data processing system, the visual data being adapted for consumption by a user of the data processing system and not being natively interpretable by an executing entity of the data processing system;
inferring, by the management controller and using the visual data, an occurrence of an event impacting operation of the in-band components of the data processing system;
identifying, by the management controller, a remediation process to manage an impact of the occurrence; and
initiating, by the management controller, performance of the remediation process by the data processing system to place the data processing system in a desired operating state to facilitate continued provisioning of desired computer implemented services.

18. The system of claim 17, wherein the operations further comprise:
after inferring the occurrence of the event:
performing, by the management controller and using a side band channel between the management controller and at least one of the in-band components, an event verification process for the occurrence; and
in a first instance of the performing where the event verification process for the occurrence indicates that the occurrence is valid:
concluding that the data processing system is at least partially impaired,
wherein the remediation process is identified in response to the concluding that the data processing system is at least partially impaired.

19. The system of claim 18, wherein performing the event verification process comprises:
obtaining, using the side band channel, telemetry data for the at least one of the in-band components, the telemetry data indicating characteristics of the at least one of the in-band components during the occurrence of the event;
making a determination regarding whether the telemetry data is consistent with the visual data with respect to the occurrence of the event; and
in a first instance of the determination where the telemetry data is consistent with the visual data:
concluding that the occurrence is valid.

20. The system of claim 17, wherein the visual data comprises a screenshot of an interface of the data processing system while the in-band components are performing a process, the interface indicating a status of the process and/or an operating state of the in-band components.
